(19) United States
(12) Patent Application Publication
(10) Pub. No.: US 2026/0286676 A1
(43) Pub. Date: Sep. 24, 2026

(54) GRIPPER, GRIPPING SYSTEM, AND USE OF A GRIPPER

(71) Applicant: BODUS GMBH, Aarau (CH)

(72) Inventor: Muarem USUL, Oftringen (CH)

(21) Appl. No.: 19/480,198

(22) PCT Filed: May 2, 2024
(86) PCT No.: PCT/EP2024/062140

§ 371 Date: Oct. 30, 2025

(30) Foreign Application Priority Data
May 2, 2023 (EP) 23170968.4

(51) Int. Cl. E03F 9/00; B25J 15/10

(52) U.S. Cl. CPC E03F 9/002; B25J 15/10

(57) ABSTRACT

The invention relates to gripping tongs (10) for gripping objects, in particular in a sewer system, having
at least one housing (11) with a central axis;
at least one piston (12), which is arranged in the housing (11) in a slidable manner along the central axis; and
a plurality of gripping arms (13), each of which is mounted pivotably in and/or on the housing (11) about a joint axis,
   wherein the gripping tongs have at least one lifting element (14) connected to the piston (12), which is coupled to the gripping arms (13) in such a way that when the piston (12) performs a stroke movement away from the gripping arms (13), the gripping arms (13) move from an open position to a closed position.

### DESCRIPTION

The invention relates to gripping tongs, a gripping system, and the use of such gripping tongs or such a gripping system. Gripping tongs according to the preamble of claim 1 are known, for example, from DE 20 2010 012 511U 1 .

In water, manholes and sewer pipes, objects can often accumulate restricting or even blocking the flow in the pipe. Such objects can, for example, be foreign bodies that end up in the pipe system or are formed by the deposition of solids in the pipe. To prevent the pipes from becoming blocked, these objects are often removed from the respective pipe using a pair of gripping tongs.

For example, DE 20 2010 012 511 U 1 mentioned above describes gripping tongs that have gripping arms that can be actuated by compressed air. To close the gripping arms, a piston is pressurized with compressed air and moved in the direction of the gripping arms. The piston interacts with the ends of the gripping arms to move the gripping arms from an open position to a closed position. The piston is guided in a housing in which the gripping arms are also mounted pivotably. In the non-actuated state, a first spring is used to return the piston to its initial position, and multiple second springs are used to open the gripping arms.

The gripping tongs according to DE 20 2010 012 511 U 1 have a relatively long design due to its construction, which makes it difficult to guide it in pipes, especially in areas of curves, bends, and branches.

The present invention is therefore based on the problem to indicate a pair of gripping tongs for gripping objects, which has a compact design and simplified handling due to an improved design. Further, the present invention is based on the problem to indicate a gripping system and the use of a pair of gripping tongs and a gripping system.

According to the invention, this problem is solved with regard to the gripping tongs by the subject-matter of claim 1. With regard to the gripping system, the above-mentioned problem is solved by the subject-matter of claim 15 and with regard to the use, the above-mentioned problem is solved by the subject-matter of claim 16.

Specifically, the problem is solved by means of gripping tongs for gripping objects, in particular in a sewer system, having at least one housing with a central axis, at least one piston which is arranged in the housing in a slidable manner along the central axis, and a plurality of gripping arms which are each pivoted in and/or on the housing about a joint axis.

According to the invention, the gripping tongs have at least one lifting element connected to the piston, which is coupled to the gripping arms in such a way that when the piston performs a stroke movement away from the gripping arms, the gripping arms move from an open position to a closed position.

In other words, the gripping arms are pulled from the open position to the closed position by the piston, wherein the lifting element is connected to the piston on the one hand and coupled to the gripping arms on the other. The lifting element thus serves as a connecting part between the piston and the gripping arms in order to transfer the stroke movement of the piston into a rotary movement around the joint axes of the gripping arms. The lifting element is thus adapted in such a way that the gripping arms close when the piston performs a stroke movement away from the gripping arms. This corresponds to a gripping situation in which the gripping tongs can grasp one or more objects.

The coupling of the lifting element with the gripping arms in accordance with the invention results in a structurally simple and compact design of the gripping tongs, particularly with regard to the length of the gripping tongs. This means that the gripping tongs can be quickly and easily guided in a pipeline system during use. In particular, the gripping tongs can be guided more easily in direction-changing pipeline passages, for example in curves, bends, branches, or the like, and thus can be handled more easily on the whole.

The lifting element is connected to the piston. The lifting element and the pistons are preferably jointly slidable. The lifting element is preferably movable with the piston along the central axis of the housing. The lifting element is preferably arranged on the central axis of the housing. It is particularly preferable for the lifting element to be firmly connected to the piston, in particular in a non-displaceable manner. The lifting element can be connected to the piston in a form-fitting, material-bonded and/or force-fitting manner. The lifting element can be connected to the piston directly or indirectly. Preferably, the piston is mechanically coupled to the gripping arms via the lifting element.

The housing of the gripping tongs accommodates the piston. For this purpose, the housing preferably has a piston working chamber in which the piston is arranged in a slidable manner. The housing is formed so that the piston is slidable longitudinally along the central axis of the housing. In other words, the piston is arranged in the housing so that it can move in the longitudinal direction. The piston preferably divides the piston working chamber into a first working area and a second working area.

Preferably, the housing, in particular the piston working chamber, is formed such that the piston, and in particular the lifting element, is slidable along the central axis from 0 mm to 20 mm, in particular 0 mm to 15 mm, in particular 0 mm to 10 mm. Particularly preferably, the housing, especially the piston working chamber, is formed so that the piston, and especially the lifting element, can be displaced along the central axis from 0 mm to 8 mm, preferably by at least 6 mm. This stroke movement of the piston is sufficient to move the gripping arms from the open position to the closed position and vice versa.

When the gripping tongs are actuated, i.e. when the gripping arms are transferred from the open position to the closed position, an actuating fluid, preferably compressed air, is filled under pressure into at least one of the working areas of the piston working chamber. The use of a different actuating fluid, for example a liquid, gas, or the like, is possible. Preferably, however, the pair of gripping tongs according to the invention is a pair of gripping tongs that can be actuated pneumatically.

The piston is pressurized with the actuating fluid in such a way that the piston moves away from the gripping arms along the central axis. The lifting element moves or pivots the gripping arms around their respective joint axes so that the gripping arms move into the closed position. The pair of gripping tongs is then in the gripping position.

Preferably, the gripping arms move towards each other outside the housing when being transferred from the open position to the closed position. In doing so, the gripping arms particularly preferably move towards the center axis of the housing. The gripping arms are preferably arranged around the central axis, in particular evenly, in and/or on the housing.

In a preferred embodiment, the lifting element is arranged radially between the joint axes of the gripping arms, in particular in the actuated and/or non-actuated state of the gripping tongs. Preferably, the lifting element is radially coupled to the gripping arms between the joint axes.

In the actuated state, the piston is pressurized with the actuating fluid. In the non-actuated state, no pressure is exerted on the piston by the actuating fluid. This does not exclude that at least one pressure medium may be acting on the piston, for example to reset the position.

The gripping tongs are preferably used for gripping and/or removing objects from a water system, in particular waste water, sewer and/or manhole system. The gripping tongs are particularly suitable for inserting into pipes, especially pipelines, and removing objects such as deposits, dirt, fine and/or coarse solids. Alternatively, it is possible that the gripping tongs can be used for other gripping activities, for example outside of such systems or pipelines.

In a preferred embodiment, the gripping arms have at least one first, in particular short, leg, which is arranged at least in sections within the housing and is guided in a form-fitting manner on the lifting element for rotating the gripping arms about the joint axis. The first leg forms here a lever mechanism with the lifting element, which translates the lifting movement of the piston into a rotation of the gripping arms around the joint axes. The lever mechanism enables a particularly compact design of the gripping tongs.

The first leg is preferably a shorter one of at least two legs of the gripping arms. The first leg of the gripping arms extends from the joint axis to the lifting element. The first leg preferably comprises at least one claw-shaped leg end that engages in the lifting element.

In a preferred further embodiment, the gripping arms are formed in an L-shaped, wherein at least a second leg of the gripping arms extends at least in sections, in particular for the most part, outside the housing for gripping an object. The second leg of the gripping arms extends outwards from the joint axis. The second leg is preferably longer than the first leg of the gripping arms. The second leg has a free end outside the housing. The second leg preferably comprises a hook form at the free end to provide a better grip on the object when gripping.

The lifting element is preferably arranged on a first piston rod section, which is connected to the piston and starting from the piston, extends along the central axis in a first direction, in particular a direction facing the gripping arms. In other words, the first piston rod section extends in the longitudinal direction of the housing towards the gripping arms. The first piston rod section is preferably an elongated extension on which the lifting element is arranged. It is advantageous if the first piston rod section is a cylindrical extension. This enables improved guidance of the piston during a stroke movement.

Preferably, the lifting element is connected in a non-slidable manner to the first piston rod section. The lifting element may be connected to the first piston rod section in a material-bonded, form-fitting, and/or force-fitting manner. The lifting element is particularly preferably bolted to the first piston rod section. In addition, the lifting element may be attached to the first piston rod section by means of an adhesive and/or a sealant in order to achieve a permanently strong connection.

The first piston rod section is preferably integrally formed with the piston. In other words, the piston and the first piston rod section are monolithic. This makes it easy to produce the piston, for example, as a turned part. Alternatively, the first piston rod section may form a separate component that is connected to the piston. For example, the first piston rod section may be screwed into the piston.

Further preferably, the lifting element has several cutouts on an outer circumference into which the gripping arms engage, in particular with the claw-shaped leg ends. The lifting element preferably has at least one guiding part per cutout, in particular a pin, which runs transversely to the central axis of the housing and guides the gripping arm engaging in the cutout. The gripping tongs therefore have a simple structural design.

The guiding part preferably engages in the claw-shaped leg end of the first leg. The guiding part preferably forms a driver that moves the engaging gripping arm during a stroke movement of the piston in such a way that the gripping arm rotates around its joint axis. The guiding part preferably extends transversely to the central axis of the housing.

Particularly preferably, the gripping tongs comprise at least one first spring element, in particular a first conical compression spring, which interacts with the lifting element in such a way that the lifting element holds the gripping arms in the open position when the piston is in a non-actuated state. The first spring element is preferably a first return spring in order to move the piston to its initial position in the non-actuated state and thus transfer the gripping arms from the closed position to the open position. The first spring element may be a first volute spring or a first, in particular multi-layered, wave spring. Other spring types are possible.

Preferably, the first spring element is arranged concentrically to the central axis of the housing. This ensures that the spring pressure is homogeneously distributed in the lifting element. Additionally, it contributes to the compactness of the gripping tongs.

In a preferred embodiment, the first spring element is arranged on the first piston rod section and abuts against the lifting element in order to apply a spring force against the lifting element in the central axial direction. The first spring element preferably extends around the first piston rod section. The first spring element is preferably arranged in such a way that its spring force acts in the actuated state in a direction opposite to the stroke movement of the piston.

Preferably, at least one guiding and bearing element is arranged between the piston and the lifting element, whereby the guiding and bearing element closes the/a piston working chamber of the housing. The first working area, into which the actuating fluid is introduced to close the gripping tongs, is preferably located between the piston and the guiding and bearing element. The guiding and bearing element preferably comprises at least one circumferential section that projects into the piston working chamber. The circumferential section abuts in a sealing manner against the inner wall of the housing. In addition, at least one sealant, for example an O-ring, can be arranged on the circumferential section to increase the sealing effect.

The guiding and bearing element has the advantage that the housing is divided into two areas. In a first area, the actuating fluid is located, depending on the operating state, and in the second area, the lifting movement is transferred to the gripping arms. If maintenance work is required in the second area, i.e. on the lifting element, for example, this can be opened independently of the piston working chamber. This prevents contamination of the piston chamber.

The guiding and bearing element preferably has at least one through opening in which the first piston rod section is guided in a slidable manner. In other words, the first piston rod section preferably extends through the through opening. The guiding and bearing element is used to guide the first piston rod section and thus the piston during a stroke movement, i.e. in the actuated state. In the non-actuated state, the guiding and bearing element is used to support the first piston rod section or the piston. In this embodiment, it is advantageous that the guiding and bearing element favors a compact design of the gripping tongs through functional integration.

In one embodiment, the guiding and bearing element has at least one spring seat, in particular a recess, on which the first spring element is supported. The spring seat of the guiding and bearing element forms a stationary abutment for the first spring element here. The first spring element is supported on the spring seat in such a way that the lifting element is biased with a certain spring force.

The advantage here is that the first spring element is arranged positionally fixed on the guiding and bearing element. This increases the functional reliability of the first spring element and prevents unwanted positional displacement of the first spring element.

In a preferred embodiment, the guiding and bearing element is connected to the housing in a force-fitting and/or form-fitting manner. The guiding and bearing element may have a circumferential collar that is connected to the housing. In particular, the guiding and bearing element, in particular the collar, can be arranged at least in sections between two housing parts of the housing. The housing can therefore be designed in at least two parts. The advantage here is that the guiding and bearing element is attached to or in the housing in a simple and space-saving manner.

The housing preferably has a bottom with at least one through opening in which a second piston rod section, in particular one facing away from the gripping arms, is guided in a slidable manner. The piston can therefore be guided stably along the central axis.

The second piston rod section preferably extends from the piston in a second direction, in particular away from the gripping arms, along the central axis. In other words, the second piston rod section extends in the longitudinal direction of the housing away from the gripping arms. The second piston rod section is preferably an elongated extension, which is arranged at least in sections in the through opening of the bottom. It is advantageous if the second piston rod section is a cylindrical extension. This enables improved guidance of the piston during a stroke movement in the housing bottom.

The second piston rod section is preferably integrally formed with the piston. In other words, the piston and the second piston rod section are monolithic. This makes it easy to produce the piston, for example, as a rotating part. Alternatively, the second piston rod section may form a separate component that is connected to the piston. For example, the second piston rod section may be screwed into the piston.

The housing preferably comprises at least one borehole that connects a second working area of the piston working chamber with an external environment. The second working area is located on the piston opposite the first working area. The borehole is preferably formed in the housing wall. The borehole has the advantage that, on the one hand, the air in the second working area can escape when the piston is actuated so that there is no back pressure against the piston when the gripping arms in the second working area are closed. On the other hand, air from the outside environment can flow into the second working area of the piston working chamber through the borehole when the piston moves into the initial position.

To prevent dirt from contaminating the piston working chamber, a filter is preferably arranged on the borehole. The filter preferably covers the borehole. The filter may be a sintered filter. Other filter types are possible.

Additionally or alternatively, the gripping tongs may have at least one second spring element, in particular a second conical compression spring, which interacts with the piston in such a way that the lifting element holds the gripping arms in the open position when the piston is in a non-actuated state. The second spring element supports the first spring element in order to hold the gripping arms in the open position via the lifting element in the non-actuated state. The second spring element is preferably a second return spring in order to move the piston to its initial position in the non-actuated state and thus transfers the gripping arms from the closed position to the open position. The second spring element may be a second volute spring or a second, in particular multi-layered, wave spring.

Preferably, the second spring element is arranged concentrically to the central axis of the housing. Thus, the spring pressure is uniformly distributed in the piston. This additionally contributes to the compactness of the gripping tongs.

In a preferred embodiment, the second spring element is arranged on the second piston rod section and abuts against the piston in order to apply a spring force against the piston in the central axial direction. Preferably, the second spring element is arranged in the piston working chamber, wherein the second spring element abuts against the piston in order to apply a spring force against the piston in the central axial direction. The second spring element preferably extends around the second piston rod section. The second spring element is preferably arranged in such a way that its spring force acts in the actuated state in a direction opposite to the stroke movement of the piston. The spring forces of the first and second spring elements are in the same direction. Due to the position of the second spring element being disposed in the piston working chamber the compactness of the gripping tongs is additionally increased.

Preferably, at least one channel is formed in the second piston rod section and/or the piston, which fluidly connects a connector for supplying an actuating fluid, in particular compressed air, to a/the first working area of the piston working chamber, which is formed between the guiding and bearing element and the piston. The channel preferably forms a bypass to the second working area of the piston working chamber. The advantage here is that an additional channel for supplying the actuating fluid can be omitted. This function integration reduces the complexity of the gripping tongs.

Preferably, at least one connector for supplying an actuating fluid, in particular compressed air, is connected to the housing, which has at least one circumferential form-fitting contour, in particular a hexagonal contour. The connector is preferably connected to the channel for feeding the actuating fluid into the first working area of the piston working chamber. The form-fitting contour has the advantage that a torsional force can be transmitted to the housing and thus to the entire gripping tongs via a hose, for example. This eliminates the need for a push spring. The use of an air push bar is possible.

It is advantageous if the gripping arms have at least one quick-fastening device for changing a gripping arm section, the device being arranged outside the housing. This has the advantage that the quick-fastening device is quickly and easily accessible for performing a replacement of the gripping arm section.

According to a secondary aspect, the invention relates to a gripping system with at least one pair of gripping tongs according to the invention and with at least one guiding and actuating device, in particular a hose and/or an air push bar, wherein the guiding and actuating device is connected or connectable in a torque-proof manner to a connector, in particular a compressed air connector, of the gripping tongs in order to transmit a torque. Reference is made here to the advantages explained in connection with the gripping tongs. Moreover, the gripping system may alternatively or additionally have individual features or a combination of several features mentioned above in relation to the gripping tongs.

In one use according to the invention, the pair of gripping tongs and/or the gripping system according to the invention are used for cleaning pipelines, in particular a waste water and/or sewer system.

The invention is explained in more detail below with reference to the accompanying drawings. The embodiments described represent examples of how the pair of gripping tongs or gripping system according to the invention can be configured.

In These,

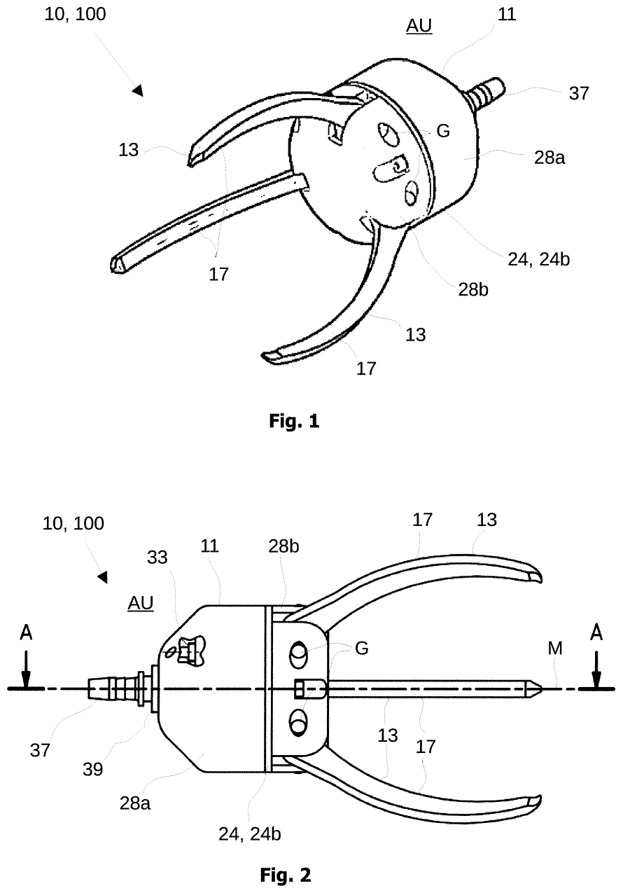

FIG. 1 illustrates a perspective view of gripping tongs according to a preferred exemplary embodiment of the invention;

FIG. 2 illustrates a side view of the gripping tongs according to FIG. 1;

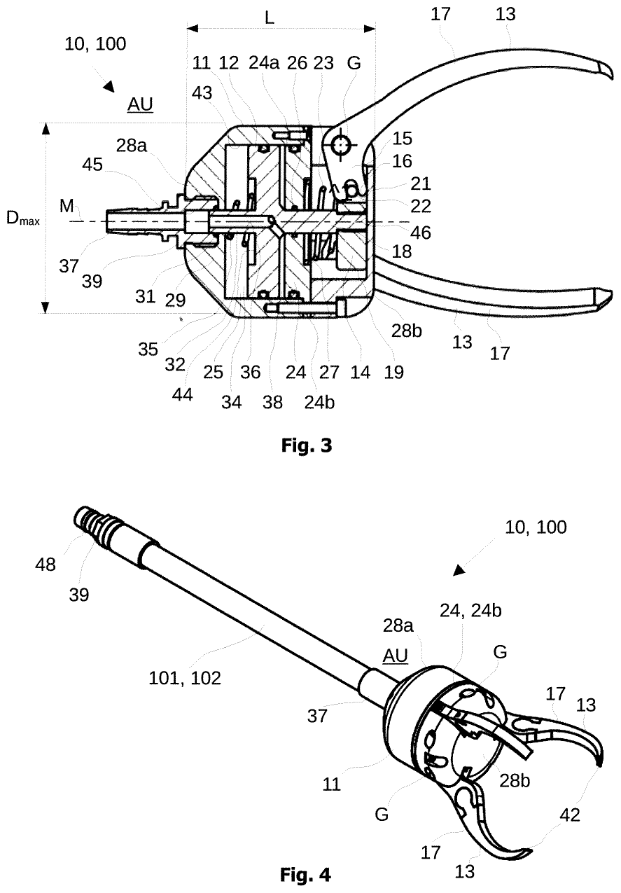

FIG. 3 illustrates a longitudinal section through the gripping tongs according to FIG. 1;

FIG. 4 illustrates a perspective view of a gripping system with gripping tongs according to a further exemplary embodiment of the invention; and

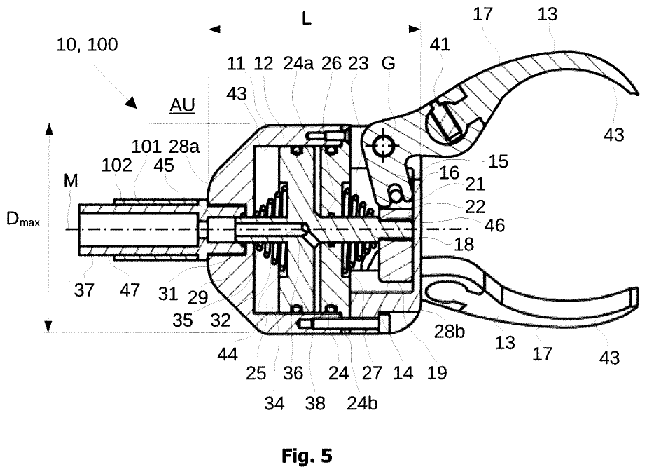

FIG. 5 illustrates a longitudinal section through the gripping tongs according to FIG. 4.

In the following description, the same reference numbers are used for identical or identically acting parts.

FIGS. 1 to 3 show gripping tongs 10 for gripping objects according to a preferred exemplary embodiment of the invention. The gripping tongs 10 are preferably used for cleaning pipes in waste water, sewer, and/or manhole systems. Other areas of application, especially outside of pipes, are possible. The gripping tongs 10 according to FIGS. 1 to 3 are gripping tongs that can be actuated pneumatically.

The gripping tongs 10 have a housing 11, a piston 12 and a plurality of gripping arms 13. The gripping arms 13 will be discussed in more detail later. The piston 12 is accommodated in the housing 11. The housing 11 has a central axis M along which the piston 12 is arranged in a slidable manner. The housing 11 is formed in two parts. The housing 11 comprises a first housing part 28a as a bottom. Furthermore, the housing 11 has a second housing part 28b as a cover. The first housing part is firmly connected to the second housing part. Specifically, the cover is screwed to the bottom of the housing 11. The housing 11 is essentially formed round on the outer circumference.

The housing 11 preferably has a maximum diameter Dₘₐₓ of 40 mm to 60 mm, particularly preferably 50 mm. In addition, the housing 11 preferably has a length L of 40 mm to 60 mm from front to front, particularly preferably of around 51 mm.

As can be clearly seen in FIG. 3, the piston 12 is accommodated in the first housing part 28a, in particular the bottom. For this purpose, the first housing part 28a has a piston working chamber 25 in which the piston 12 is arranged in a slidable manner. The piston 12 divides the piston working chamber 25 into a first working area 38 and a second working area 34.

The piston 12 is formed disk-shaped. In other words, the piston 12 is formed plate-shaped, in particular flatly. The piston 12 has preferably cylindrical formed. The piston 12 comprises receives a sealant, in particular an O-ring, on its circumference in order to seal the piston 12 against the housing 11.

As can be seen in FIG. 3, a first piston rod section 18 and a second piston rod section 32 are provided on the piston 12. Specifically, the first and second piston rod sections 18, 32 are formed integrally with the piston 12. This means that the piston 12 and the two piston rod sections 18, 32 are formed from a single piece. The two piston rod sections 18, 32 extend along the central axis M of the housing 11. The first piston rod section 18 extends in the direction of the gripping arms 13 and the second piston rod section 32 extends in a direction opposite to the first piston rod section 18. The two piston rod sections 18, 32 are arranged opposite each other on the piston 12 and extend in opposite directions.

According to FIG. 3, the piston rod sections 18, 32 each form a cylindrical extension. The first piston rod section 18 extends through the first working area 38 of the piston working chamber 25. The second piston rod section 32 extends through the second working area 34 of the piston rod chamber 25. The two piston rod sections 18, 32 lie on the central axis M of the housing 11.

Furthermore, the gripping tongs 10 have a lifting element 14, which is connected to the piston 13 via the first piston rod section 38 in a non-slidable manner. This means that the lifting element 14 can be moved with the piston 12. Specifically, the lifting element 14 is arranged at a longitudinal end of the first piston rod section 38 facing away from the piston 13. The lifting element 14 lies on the central axis M of the housing 11. The lifting element 14 is bolted to the first piston rod section 38. Specifically, the first piston rod section 38 has an external thread and the lifting element 14 has an internal thread, which engages in the external thread of the first piston rod section 38. In addition, the screw connection between the lifting element 14 and the first piston rod section 38 may be secured by means of an adhesive.

The lifting element 14 is designed in a disc-shape. In other words, the lifting element 14 is in the form of a plate, in particular a flat material. The lifting element 14 has a plurality of cutouts 21 on an outer circumference 19, into which the gripping arms 13 engage. Specifically, the lifting element 14 has one such cutout 21 per gripping arm 13, into which the gripping arm 13 partially protrudes. The cutouts 21 are formed by slots that penetrate the lifting element 14 parallel to the central axis M of the housing 11. In other words, the cutouts 21 are each open radially outwards and form a passage in the longitudinal direction of the housing 11. The lifting element 14 has a total of three cutouts 21, as the gripping tongs 10 comprise three gripping arms 13, as can be seen in FIGS. 1 and 2.

The lifting element 14 has a guiding part 22 in the form of a pin for each cutout 21. The pin is transversely arranged to the center axis M of the housing 11 in the cutout 21. Specifically, the pin extends transversely to the central axis M through the cutout 21. The pin forms a driver that pivots the engaging gripping arm 13 around its joint axis G during a stroke movement of the piston 12. The pin therefore serves to entrain the engaging gripping arm 13 during a stroke movement of the piston 12. The entraining movement or pivoting movement of the gripping arm 13 is parallel to the stroke movement of the piston 12.

The gripping arms 13 are designed essentially L-shaped. Specifically, the gripping arms 13 have a first leg 15 and a second leg 17. The first leg 15 is arranged inside the housing 11, in particular the cover of the housing 11. The second leg 17 is for the most part arranged outside the housing 11, in particular the cover. The first leg 15 is shorter than the second leg 17. In other words, the second leg 17 is longer than the first leg 15.

The first leg 15 extends from the joint axis G to the lifting element 14 and engages with a claw-shaped leg end 16 in one of the cutouts 21 of the lifting element 14. In other words, the short leg 15 of the respective gripping arm 13 has a leg end 16 with a fork shape that engages in the cutout 21 of the lifting element 14. In doing so, the guiding part 22, in particular the pin, of the lifting element 14 extends through a gap formed between two claws of the end of the leg 16. The lifting element 14 is thus coupled in a form-fitting manner with the gripping arms 13 for guiding.

During a stroke movement of the piston 12 along the central axis M, the guiding part 22 entrains the engaging gripping arm 13 via the engagement in the gap in such a way that the gripping arm 13 rotates about its joint axis G. Depending on the direction of the stroke movement of the piston 12, the gripping arms 13 are moved from the open position to the closed position or vice versa.

As can be seen in FIG. 3, the lifting element 14 is arranged radially between the joint axes G of the gripping arms 13. The gripping tongs 10 have a total of three gripping arms 13, which are distributed around the central axis M of the housing 11. In other words, the gripping arms 13 are distributed in the circumferential direction of the housing 11 and are arranged radially on the outside in relation to the central axis M. Alternatively, the gripping tongs 10 may also have two or more than three gripping arms 13. The joint axes G of the gripping arms 13 are arranged in the area of an outer circumference of the housing 11. The joint axes G are aligned transverse to the central axis M of the housing 11.

The gripping tongs 10 also have a guiding and bearing element 24, which is arranged between the piston 12 and the lifting element 14. The guiding and bearing element 24 closes the first working area 38 of the piston working chamber 25 of the housing 11. In other words, the first working area 38, into which the actuating fluid for closing the gripping tongs 10 is introduced, is located between the piston 12 and the guiding and bearing element 24. The guiding and bearing element 24 comprises a circumferential section 24a, which projects into the first working area 38 of the piston working chamber 25. The circumferential section 24a abuts in a sealing manner with an inner housing wall 43 of the housing 11, in particular the first housing part 28a. In addition, the circumferential section 24a accommodates a sealant, in particular an O-ring, in order to increase the sealing effect.

The guiding and bearing element 24 has a through opening 26 in which the first piston rod section 18 is guided in a slidable manner. In other words, the first piston rod section 18 extends through the through opening 26. The guiding and bearing element 24 has a sealing means, in particular an O-ring, which is arranged in the through opening 26 and abuts in a sealing manner against the first piston rod section 18. The guiding and bearing element 24 is used to guide the first piston rod section 18 and thus the piston 12 during a stroke movement, i.e. in the actuated state. In the non-actuated state, the guiding and bearing element 24 is used to support the first piston rod section 18 or the piston 12.

As shown in FIG. 3, the guiding and bearing element 24 has a spring seat 27 on which a first spring element 23 is supported. The spring seat 27 of the guiding and bearing element forms a stationary abutment for the first spring element 23. The first spring element 23 is supported on the spring seat 27 in such a way that the lifting element 14 is biased with a certain spring force. The first spring element 23 will be discussed in more detail later.

The guiding and bearing element 24 is connected to the housing 11 in a force-fitting and/or form-fitting manner. The guiding and bearing element 24 has a circumferential collar 24b that is connected to the housing 11. More specifically, the collar 24b is arranged between the two housing parts 28a, 28b of the housing 11.

As described above, the gripping tongs 10 have a first spring element 23, which interacts with the lifting element 14. The first spring element 23 introduces a spring force into the lifting element 14 in such a way that the gripping arms 13 are held in the open position when the piston 12 is not actuated. The first spring element 23 is arranged on the first piston rod section 18 between the guiding and bearing element 24 and the lifting element 14. The first spring element 23 sits in the spring seat 27 of the guiding and bearing element 24 and is supported by it. The first spring element 23 is a first conical compression spring, as can be clearly seen in FIG. 3. The first conical compression spring is aligned in such a way that a cone tip of the conical compression spring abuts against a contact surface of the lifting element 14.

In addition, the gripping tongs 10 have a second spring element 35, which is arranged in the second working area 34 of the piston working chamber 25.

Specifically, the second spring element 35 is arranged between the piston 12 and a bottom 29 of the first housing part 28a. The second spring element 35 interacts with the piston 12. The second spring element 35 introduces a spring force into the piston 12 in such a way that the spring force of the first spring element 23 is supplemented. Since the lifting element 14 is rigidly connected to the piston 12 via the first piston rod section 18, the spring force of the second spring element 35 is also transmitted to the lifting element 14.

Like the first spring element 23, the second spring element 35 therefore serves to hold the gripping arms 13 in the open position when the piston 12 is not actuated. The second spring element 35 is arranged on the second piston rod section 32. The second spring element 35 sits in a spring seat 44 of the piston 12 and is supported by it. The second spring element 35 is a second conical compression spring, as can be clearly seen in FIG. 3. The second conical compression spring is aligned in such a way that a cone tip of the conical compression spring abuts against a contact surface of the bottom 29 of the housing 11.

The two spring elements 23, 35 are arranged in such a way that their spring forces act in a direction opposite to the stroke movement of the piston 12 when the piston 12 is actuated. In the non-actuated state, the spring elements 23, 35 therefore serve to return the piston 12 to its initial position, and thus to transfer the gripping arms 13 from the closed position to the open position. Therefore, the spring forces of the first and second spring elements 23, 35 are in the same direction.

The bottom 29 of the housing 11 has a through opening 31 that is concentric to the central axis M. The second piston rod section 32 is partially arranged in the through opening 31. The second piston rod section 32 projects with an end region facing away from the piston 12 into the through opening 31 of the bottom 29. The bottom 29 is part of the first housing part 28a. Specifically, the second piston rod section 32 engages in a slidable manner in the through opening 31. In other words, the second piston rod section 32 is guided in the through opening 31 so that it can be moved longitudinally.

The gripping tongs 10 also have a connector 37 for a guiding and actuating device. In the present example, the connector 37 is designed as a connecting nipple that is screwed into the bottom 29 of the housing 11. The connecting nipple comprises a passage 45, in which the second piston rod section 32 is guided in a slidable manner. The second piston rod section 32 partially engages with its end region in the passage 45. The passage 45 lies on the central axis M of the housing 11 and is concentric with the second piston rod section 32.

The connector 37 has a circumferentially formed form-fit contour. The form-fit contour is a hexagonal contour 39. The connector 37 is connected to the bottom 29 of the housing 11 such that a torsional force can be introduced into the housing 11 via the hexagonal contour 39. This enables a rotation of the gripping tongs 10 around the central axis M.

In general, the connector 37 is used to supply an actuating fluid, which in this case is compressed air, and to rotate the gripping tongs 10. When the piston 12 is actuated, compressed air is introduced through the connector 37. The second piston rod section 32 has an integrated channel 36, which fluidly connects the passage 45 of the connector 37 with the first working area 38 of the piston working chamber 25. When actuated, the compressed air is therefore introduced from the connector 37 through the channel 36 into the first working area 38 of the piston working chamber 25.

As a result, a compressive force acts on the piston 12 in the first working area 38, which moves the piston 12 and thus the lifting element 14 in a direction away from the gripping arms 13 along the central axis M of the housing 11. This corresponds to a stroke movement of the piston 12 away from the gripping arms 13. The first and second spring elements 23, 35 are compressed by the piston 12 or the lifting element 14 during this lifting movement.

So that the air located in the second working area 34 can escape during such a stroke movement, the housing 11, in particular the first housing part 28a, has a borehole 33 which connects the second working area 34 of the piston working chamber 25 to an external environment AU. The borehole 33 is clearly visible in FIG. 2. Preferably, a filter is arranged on the borehole 33, which prevents dirt from being sucked in when the piston 12 is returned to its initial position. The filter may be a sintered filter.

The form-fit coupling of the lifting element 14 with the gripping arms 13 causes them to be pivoted about the joint axes G in such a way that the gripping arms 13 are transferred from an open position to a closed position. In doing so, the second legs 17 of the gripping arms 13 move towards each other outside the housing 11.

As long as compressed air is supplied to the first working area 38 through the connector 37 and the piston 12 is thus pressurized, the gripping arms 13 are in the closed position. If compressed air is no longer supplied, i.e. no more pressure acts on the piston 12 in the first working area 38, the compressed spring elements 23, 35 move the piston 12 and the lifting element 14 back to their initial position. This can only be done in the non-actuated state. The first and second spring elements 23, 35 are each a return spring. In order to limit a stroke movement of the piston 12 or the lifting element 14 towards the gripping arms 13 when the piston 12 is not actuated, the housing 11, in particular the second housing part 28b, has a stop surface 46 on the inside against which the lifting element 14 abuts in the initial position (see FIG. 3).

According to FIGS. 4 and 5, gripping tongs 10 according to a further embodiment example according to the invention are shown, which differ from the gripping tongs 10 according to FIGS. 1 to 3 only in the shape of the connector 37 and the second legs 17 of the gripping arms 13. All the other features of the gripping tongs 10 shown in FIGS. 1 to 3 described above are also comprised in the gripping tongs 10 shown in FIGS. 4 and 5. Also, the gripping tongs 10 in FIGS. 4 and 5 are actuated as described above.

The connector 37 of the gripping tongs 10 as shown in FIGS. 4 and 5 has a cylindrical section 47 for receiving a hose 102. In contrast to the gripping tongs 10 shown in FIGS. 1 and 3, the connector 37 does not have a form-fit contour in the form of a hexagonal contour. The gripping tongs 10 according to FIGS. 4 and 5 have a further connector 48, which is arranged opposite the connector 37 on the hose 102. The further connector 48 is fluidly connected to the hose 102. The further connector 48 comprises a circumferentially formed form-fit contour, specifically a hexagonal contour 39.

The hose 102 is part of a guiding and actuating device 101, which guides the pair of gripping tongs 10 in use through a pipe and, if necessary, supplies compressed air to the gripping tongs 10 to actuate the piston 12 in order to close the gripping arms 13.

The combination of a pair of gripping tongs 10 and the guiding and actuating device 101 form a gripping system 100, which is shown in FIG. 4, for example.

Furthermore, in contrast to the gripping tongs 10 shown in FIGS. 1 to 3, the gripping arms 13 are formed in a split manner. Specifically, the second leg 17 of the gripping arms is divided into two parts. The second leg 17 comprises a quick-fastening device 41, by means of which a gripping arm section 42 of the second leg 17 is held in a replaceable manner. The quick-fastener system 41 is integrated into the second leg 17. As shown in FIG. 5, the quick-fastener system 17 comprises a spring and a pin that form-fittingly secures the replaceable gripping arm section 42. The pin is inserted through the spring into a form-fit opening. To exchange the gripping arm section 42, the pin must be moved by hand against the spring force of the spring so that the form-fit connection is released.

It should be noted here that individual or several features of the two embodiments of the gripping tongs 10 shown in FIGS. 1 to 3 and FIGS. 4 and 5 may be freely combined with one another. For example, the gripping tongs 10 according to FIGS. 1 to 3 may also have at least one replaceable gripping arm section 42.

### LIST OF REFERENCE NUMBERS

10 Gripping tongs
11 Housing
12 Piston
13 Gripping arms
14 Lifting element
15 First leg of the gripping arms
16 Claw-shaped leg end
17 Second leg of the gripping arms
18 First piston rod section
19 Outer circumference of the lifting element
21 Cutouts
22 Guide section
23 First spring element
24 Guiding and bearing element
24a Circumferential section of the guiding and bearing element
24b Circumferential collar
25 Piston working chamber
26 Through opening of the guiding and bearing element
27 Spring seat of the guiding and bearing element
28a First housing part
28b Second housing part
29 Bottom
31 Through opening of the bottom
32 Second piston rod section
33 Borehole
34 Second work area
35 Second spring element
36 Sewer
37 Connector
38 First work area
39 Hexagonal contour
41 Quick-fastening device
42 Replaceable gripping arm section
43 Inner wall of housing
44 Spring seat of the piston
45 Passage of the connector/further connector
46 Stop surface on the inner side
47 Cylindrical section
48 Further connector
100 Gripping system
101 Guiding and actuating device
102 Hose
M Center axis
G Joint axis
AU Outer environment
L Length of the housing
Dₘₐₓ Maximum diameter of the housing

1. Gripping tongs for gripping objects having
at least one housing with a central axis;
at least one piston, which is arranged in the housing in a slidable manner along the central axis; and
a plurality of gripping arms, each of which is mounted pivotably in and/or on the housing about a joint axis, characterized by
at least one lifting element connected to the piston, which is coupled to the gripping arms in such a way that when the piston performs a stroke movement away from the gripping arms, the gripping arms move from an open position to a closed position.

2. The gripping tongs according to claim 1,
characterized in that
the gripping arms have at least one first short leg, at least sections of which are arranged within the housing and which is guided in a form-fitting manner on the lifting element for rotation of the gripping arms about the joint axis, wherein the first leg has at least one claw-shaped leg end in which the lifting element engages.

3. The gripping tongs according to claim 1,
characterized in that
the gripping arms are designed in an L-shape, wherein at least a second long leg of the gripping arms extends at least in sections, for the most part, outside the housing for gripping an object.

4. The gripping tongs according to claim 1,
characterized in that
the lifting element is arranged on a first piston rod section, which is connected to the piston and, starting from the piston, extends along the central axis (M) in a first direction, facing the gripping arms.

5. The gripping tongs according to claim 2,
characterized in that
the lifting element has a plurality of cutouts on an outer circumference, in which the gripping arms engage with the claw-shaped leg ends, wherein the lifting element has at least one guiding part, pin per cutout, which extends transversely to the central axis (M) of the housing and guides the gripping arm engaging in the cutout.

6. The gripping tongs according to claim 1,
characterized in that
at least one first spring element, conical compression spring is provided which interacts with the lifting element in such a way that the lifting element holds the gripping arms in the open position in a non-actuated state of the piston, wherein the first spring element is arranged on the first piston rod section and abuts against the lifting element in order to apply a spring force in the direction of the central axial against the lifting element.

7. The gripping tongs according to claim 1,
characterized in that
at least one guiding and bearing element arranged between the piston and the lifting element, wherein the guiding and bearing element seals a piston working chamber of the housing.

8. The gripping tongs according to claim 7,
characterized in that
the guiding and bearing element has at least one through opening in which the first piston rod section is guided in a slidable manner, and/or the guiding and bearing element has at least one spring seat, recess, on which the first spring element is supported.

9. The gripping tongs according to claim 7,
characterized in that
the guiding and bearing element is connected to the housing in a force-fitting and/or form-fitting manner, wherein the guiding and bearing element is arranged at least in sections between two housing parts of the housing.

10. The gripping tongs according to claim 7,
characterized in that
the housing has a bottom with at least one through opening, in which a second piston rod section facing away from the gripping arms is guided in a slidable manner, and/or the housing comprises at least one borehole which connects a second working region of the piston working chamber to an external environment (AU), wherein in particular at least one filter covers the borehole.

11. The gripping tongs according to claim 7,
characterized in that
at least one second spring element, conical compression spring is provided which interacts with the piston in such a way that the lifting element holds the gripping arms in the open position in a non-actuated state of the piston, wherein the second spring element is arranged in the piston working chamber and abuts against the piston in order to apply a spring force in the direction of the central axial against the piston.

12. The gripping tongs according to claim 10,
characterized in that
at least one channel is formed in the second piston rod section and/or the piston, which fluidly connects a connector for supplying an actuating fluid with a first working region of the piston working chamber, which is formed between the guiding and bearing element and the piston.

13. The gripping tongs according to claim 1,
characterized in that
at least one connector for supplying an actuating fluid is connected to the housing, which has at least one circumferentially formed form-fitting contour.

14. The gripping tongs according to claim 1,
characterized in that
the gripping arms have at least one quick-fastening device for changing a gripping arm section, which is arranged outside the housing.

15. A gripping system having at least gripping tongs according to claim 1 and having at least one guiding and actuating device, hose and/or an air push rod, wherein the guiding and actuating device are connected or connectable in a torque-proof manner to a connector of the gripping tongs in order to transmit a torque.

16. A method of cleaning pipelines comprising gripping the pipelines with the gripping tongs according to claim 1.

17. A method of cleaning waste water or sewer system pipelines comprising gripping the pipelines with the gripping tongs system according to claim 15.

18. The gripping tongs of claim 13 wherein the actuating fluid is compressed air and the form-fitting contour is hexagonal.
